(19) United States
(12) Patent Application Publication
(10) Pub. No.: US 2006/0294221 A1
(43) Pub. Date: Dec. 28, 2006

(54) System for programmatically controlling measurements in monitoring sources

(76) Inventors: Sven Graupner, Mountain View, CA (US); Keith I. Farkas, San Carlos, CA (US); Jerome Rolia, Kanata (CA); Martin F. Arlitt, Calgary (CA)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/158,777

(22) Filed: Jun. 22, 2005

(51) Int. Cl. G06F 15/173

(52) U.S. Cl. 709/224

(57) ABSTRACT

According to one embodiment, a method comprises providing a metric reporting configuration interface for enabling configuration of metrics included in monitoring data collected for at least one monitored component. The method further comprises supporting, by the metric reporting configuration interface, defining of configuration parameters of at least one metric to be reported in monitoring data collected for the at least one monitored component. The method further comprises collecting monitoring data for the at least one monitored component, and reporting the monitoring data in accordance with the defined configuration parameters.

### CROSS-REFERENCE TO RELATED APPLICATIONS

This application is related to concurrently filed and commonly assigned U.S. patent application Ser. Nos. [Attorney Docket No. 200404993-1] entitled “SYSTEM AND METHOD FOR AUTONOMOUSLY CONFIGURING A REPORTING NETWORK NETWORK”; [Attorney Docket No. 200404992-1] entitled “A MODEL-DRIVEN MONITORING ARCHITECTURE”; [Attorney Docket No. 200404994-1] entitled “SYSTEM FOR METRIC INTROSPECTION IN MONITORING SOURCES”; and [Attorney Docket No. 200405195-1] entitled “SYSTEM AND METHOD FOR USING MACHINE-READABLE META-MODELS FOR INTERPRETING DATA MODELS IN A COMPUTING ENVIRONMENT”, the disclosures of which is hereby incorporated herein by reference.

### FIELD OF THE INVENTION

The following description relates in general to monitoring systems, and more particularly to systems and methods for programmatically controlling measurements in monitoring sources.

### DESCRIPTION OF RELATED ART

Computing systems of various types are widely employed today. Data centers, grid environments, servers, routers, switches, personal computers (PCs), laptop computers, workstations, devices, handhelds, sensors, and various other types of information processing devices are relied upon for performance of tasks. Monitoring systems are also often employed to monitor these computing systems. For instance, monitoring systems may be employed to observe whether a monitored computing system is functioning properly (or at all), the amount of utilization of resources of such monitored computing system (e.g., CPU utilization, memory utilization, I/O utilization, etc.), and/or other aspects of the monitored computing system. In general, monitoring instrumentation (e.g., software and/or hardware) is often employed at the monitored system to collect information, such as information regarding utilization of its resources, etc. The collected information, which may be referred to as “raw metric data,” may be stored to a data store (e.g., database or other suitable data structure) that is either local to or remote from the monitored computing system, and monitoring tools may then access the stored information. In some instances, tasks may be triggered by the monitoring tools based on the stored information. For example, a monitoring tool may generate utilization charts to display to a user the amount of utilization of resources of a monitored system over a period of time. As another example, alerts may be generated by the monitoring tool to alert a user to a problem with the monitored computing system (e.g., that the computing system is failing to respond). As still another example, the monitoring tool may take action to re-balance workloads among various monitored computing systems (e.g., nodes of a cluster) based on the utilization information observed for each monitored computing system.

Today, monitoring data is collected in the form of metrics that are defined and observed for a monitored computing system. In general, instrumentation and/or monitoring sources are manually configured regarding the metrics that are reported in the monitoring data collected for a given monitored computing system. Such reporting configuration may include manually configuring which metrics are to be reported (e.g., CPU utilization, memory utilization, I/O utilization, etc.), the rate at which the metrics are reported, the destination to which the metrics are to be reported (e.g., a distribution list), and the format of the reported metrics. If a change is desired in the metric reporting configuration, the monitoring source must be manually re-configured. Further, if multiple monitoring sources are implemented and a change is desired across all of such monitoring sources, each monitoring source must be individually manually re-configured. Such manual configuration or re-configuration of a monitoring source generally involves a user editing the configuration file of each monitoring source, and then restarting the monitoring source. This process is not only time consuming but is also error prone and limits the rate at which changes can be applied.

For improved efficiency and flexibility, we have recognized a desire to provide improved control over metric reporting configuration in a monitoring source. More specifically, we have recognized a desire for an interface to a monitoring source that allows for programmatic configuration (and re-configuration) of metric reporting configurations, rather than requiring the above-described manual configuration.

### BRIEF DESCRIPTION OF THE DRAWINGS

FIG. 1 shows an exemplary system according to one embodiment of the present invention;

FIG. 2 shows an exemplary operational flow according to certain embodiments of the present invention;

FIG. 3 shows an exemplary system according to one embodiment of the present invention, which shows an exemplary implementation of a monitoring source in more detail;

FIG. 4 shows an operational flow for the exemplary monitoring store of FIG. 3 in accordance with one embodiment of the present invention;

FIG. 5 shows an exemplary system according to one embodiment of the present invention in which raw metric data delivery is decoupled from delivery of processed data; and

FIG. 6 shows an exemplary system that illustrates a scenario of migrating an application in a monitoring environment according to one embodiment of the present invention.

### DETAILED DESCRIPTION

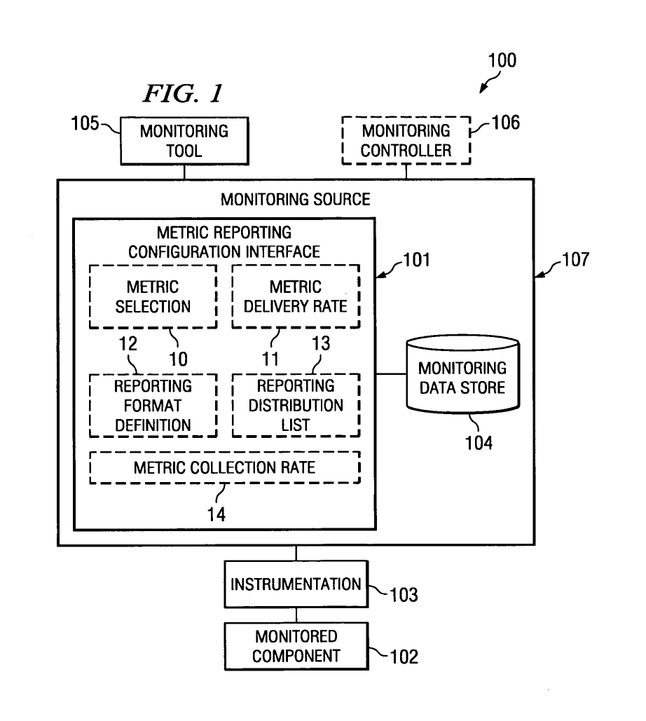

Embodiments of the present invention provide an interface for programmatically configuring metrics reported in monitoring data collected for a monitored component. FIG. 1 shows an exemplary system 100 according to one embodiment of the present invention. System 100 includes monitored component 102 that has associated therewith monitoring instrumentation 103 for collecting monitoring data. For instance, as is well-known in the art, monitoring instrumentation 103 may comprise hardware and/or software for collecting information about monitored component 102, which may also be referred to herein as a “monitored computing system.” Monitored component 102 may comprise any type of monitored computing system, such as a data center, grid environment, server, router, switch, personal computer (PC), laptop computer, workstation, devices, handhelds, sensors, or any other information processing device and/or application executing on an information processing device. While one monitored component 102 and associated monitoring instrumentation 103 is shown in the exemplary system 100, embodiments of the present invention may be employed for any number of monitored components and monitoring instrumentation.

System 100 further includes a monitoring source 107. In general, a monitoring source 107 is a component that gathers or stores monitoring data about monitored components, such as monitored component 102, in an environment. Monitoring sources commonly include a monitoring data store 104 for storing monitoring data collected for monitored component 102. This exemplary embodiment further includes metric reporting configuration interface 101 for enabling reporting of metrics to be programmatically configured, as described further herein. In certain embodiments, metric reporting configuration operations are supported for configuring one or more of the following configuration parameters: metric selection 10, metric delivery rate 11, reporting format definition 12, reporting distribution list 13, priority, or utility (as notion of “value” of monitoring data), and/or metric collection rate 14, as illustrated by the optional dashed-line boxes shown in FIG. 1. Additional or alternative configuration parameters that may be supported in certain embodiments include delivery latency and collection latency, as further examples. Multiple configuration changes may be specified at any given time via configuration interface 101, and such changes may be implemented in an atomic manner by configuration interface 101.

The monitoring data for monitored component 102 collected by monitoring instrumentation 103 is stored to monitoring data store 104. Such data store 104 may be stored to any suitable form of computer-readable storage medium, such as memory (e.g., RAM), a hard drive, optical disk, floppy disk, tape drive, etc., and may store the monitoring data in the form of a database or any other suitable data structure. In certain implementations, a given monitoring data store 104 may store monitoring data for a plurality of different monitored components. In certain embodiments, the monitoring data is communicated by monitoring instrumentation 103 to monitoring data stores 104 via a communication network (not shown), such as the Internet or other wide-area network (WAN), a local area network (LAN), a telephony network, a wireless network, or any other communication network that enables two or more information processing devices to communicate data. The monitoring data stored therein may comprise any number of metrics collected for monitored component 102, such as CPU utilization, memory utilization, I/O utilization, etc. In certain embodiments, the monitoring data stored to monitoring data store 104 is configured in accordance with metric reporting configurations defined for such monitoring data. That is, the metrics that are included in the monitoring data for monitored component 102, the metric delivery rate (how often such metrics are reported for monitored component 102), the reporting format, and/or other aspects of the metrics of the monitoring data are defined by reporting configurations. As described further below, such metric reporting configurations may be defined (e.g., dynamically changed) via metric reporting configuration interface 101.

A monitoring tool 105 is further implemented in system 100, which is operable to access (e.g., via a communication network) the collected monitoring data in monitoring data store 104. As used herein, a “monitoring tool” refers to any device that is operable to access the collected monitoring data for at least one monitored component. Monitoring tool 105 may comprise a server, PC, laptop, or other suitable information processing device, which may have one or more software applications executing thereon for accessing the monitoring data in monitoring data store 104 for one or more monitored components, such as monitored component 102. Monitoring tool 105 may be implemented, for example, to take responsive actions based on such monitoring data. As described further herein, monitoring data may be pushed from monitoring source 107 to monitoring tool 105 in certain embodiments, and monitoring data may be pulled from monitoring source 107 by monitoring tool 105 in other embodiments.

In accordance with embodiments of the present invention, the metrics reported (e.g., in monitoring data store 104 and/or to a monitoring tool 105) for monitored component 102 can be programmatically configured via metric reporting configuration interface 101. As described further herein, metric reporting configuration interface 101 may support operations for defining such configuration parameters as a) selecting metrics to be reported in the monitoring data (block 10 of FIG. 1), b) specifying delivery rate for metrics to be reported in the monitoring data (block 11 of FIG. 1), c) defining reporting format, such as XML, CIM, or Open View reporting format for the metrics included in the monitoring data (block 12 of FIG. 1), d) specifying a list of recipients to whom the metrics in the monitoring data are to be reported or the recipients who are to be made aware of data updates (block 13 of FIG. 1), and/or e) specifying a metric collection rate (block 14 of FIG. 1) defining the rate of which metrics are collected for monitored component(s). In certain embodiments, monitoring tool 105 and/or a monitoring controller may be communicatively coupled (e.g., via a network) to monitoring source 107, and any such device may communicate instructions supported by metric reporting configuration interface 101 to define configuration parameters as desired for metric reporting by monitoring source 107. Accordingly, manual configuration/re-configuration is not required, but rather interface 101 supports instructions for programmatically defining metric reporting configuration parameters. In certain embodiments, the configuration parameters may be autonomously changed (e.g., by monitoring source 107, monitoring controller 106, and/or monitoring tool 105) responsive to certain conditions being detected in the monitoring data. For instance, upon monitoring tool 105 detecting a value of a particular metric reported in the monitoring data (e.g., the value of CPU utilization) being above a threshold, such monitoring tool 105 may provide instructions to monitoring source 107 via metric reporting configuration interface 101 to change the frequency at which such metric value is reported (delivery rate) so that monitoring tool 105 can more closely monitor the metric.

Further, in certain embodiments, the configuration parameters may be autonomously changed (e.g., by monitoring source 107, monitoring controller 106, and/or monitoring tool 105) responsive to certain changes occurring in the monitored environment. For instance, a monitored component 102 may migrate within a monitored environment (e.g., from one data center to another), such that the migrated monitored component 102 may be monitored by a different monitoring source 107. Thus, the new monitoring source 107 that is associated with the monitoring component may enable the configuration of data collection for the component via metric reporting configuration interface 101. A monitoring tool may become aware of the support for configuration of data collection for the component by monitoring source 107 and cause the desired configuration.

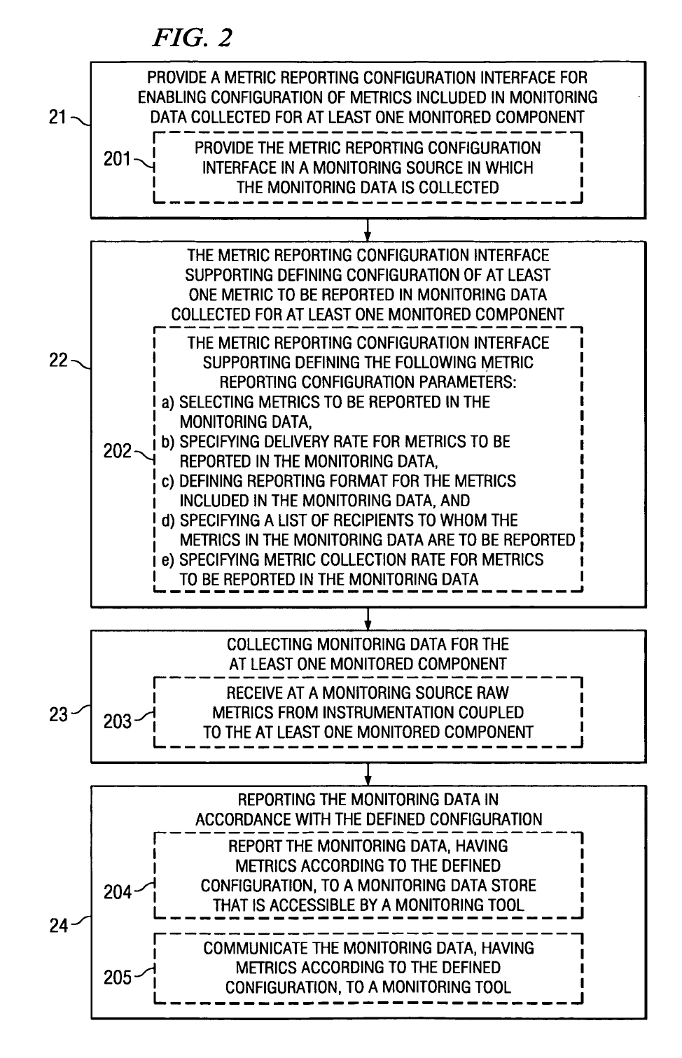

FIG. 2 shows an exemplary operational flow according to certain embodiments of the present invention. In operational block 21, a metric reporting configuration interface 101 for enabling configuration of metrics included in monitoring data collected for at least one monitored component 102 is provided. As shown in optional sub-operational block 201, in certain embodiments the metric reporting configuration interface 101 is provided in a monitoring source 107 in which the monitoring data is collected. In an alternative embodiment, reporting configuration interface 101 is provided in a monitoring source 107 that acts as an aggregator of monitoring data collected by zero or more components and zero or more other monitoring sources 107. In certain embodiments, the metric reporting configuration interface enables programmatic configuration (i.e., via computer instructions supported by such metric reporting configuration interface) of the metrics included in the monitoring data collected for a monitored component. As is well known in the art, an “interface” generally refers to a boundary between two or more objects, which allows information to flow between the objects. In certain embodiments, the configuration parameters defined for a monitoring architecture may be stored to a database, configuration file, or other suitable data structure, and the metric reporting configuration interface 101 supports programmatically defining (or changing a defined) configuration, as described further herein.

In operational block 22, the metric reporting configuration interface 101 supports defining configuration parameters of at least one metric to be reported in monitoring data collected for the at least one monitored component 102. As shown in sub-operational block 202, in certain embodiments the metric reporting configuration interface 101 supports defining the following metric reporting configuration parameters: a) selecting metrics to be reported in the monitoring data (block 10 of FIG. 1), b) specifying delivery rate for metrics to be reported in the monitoring data (block 11 of FIG. 1), c) defining reporting format for the metrics included in the monitoring data (block 12 of FIG. 1), d) specifying a list of recipients to whom the metrics in the monitoring data are to be reported or who are to be made aware of data updates (block 13 of FIG. 1), and e) specifying metric collection rate for the metrics to be reported in the monitoring data.

In operational block 23, monitoring data is collected for the at least one monitored component. As shown in sub-operational block 203, in certain embodiments this comprises receiving at a monitoring source 107 raw metrics from instrumentation 103 coupled to the at least one monitored component 102. In operational block 24, the monitoring data is reported in accordance with the defined configuration. For instance, in certain embodiments, the monitoring data, having metrics according to the defined configuration, is reported to a monitoring data store 104 that is accessible by a monitoring tool 105, as shown by sub-operational block 204. Thus, the monitoring data having metrics configured according to the defined configuration parameters may be stored for access by a monitoring tool 105 in certain embodiments. Additionally or alternatively, in certain embodiments the monitoring data having metrics configured according to the defined configuration parameters may be communicated to a monitoring tool 105, as shown by sub-operational block 205. That is, instead of or in addition to storing such monitoring data, the monitoring data may be communicated from a monitoring source 107 to a monitoring tool 105 or an event may be sent to the monitoring tool 105 signaling that the data is available. Thus, monitoring data may be communicated to the monitoring tool via pushing such monitoring data from the monitoring source 107 to the monitoring tool 105 or via notifying (e.g., by an event) the monitoring tool 105 that the monitoring data is available at the monitoring source 107 so that the monitoring tool 105 may then pull the monitoring data from the monitoring source 107 when desired. Alternatively, in another embodiment, the monitoring tool may poll the monitoring source 107 to learn whether the monitoring data is available. This polling is done via the control interface. Data is either pushed to the monitoring tool 105 or read by the monitoring tool using the monitoring data interface. In either case, the data may be delivered via a reporting network, such as the exemplary reporting network described further in co-pending and commonly assigned U.S. Patent Application Serial No. [Attorney Docket No. 200404993-1 titled “SYSTEM AND METHOD FOR AUTONOMOUSLY CONFIGURING A REPORTING NETWORK NETWORK”, the disclosure of which is hereby incorporated herein by reference.

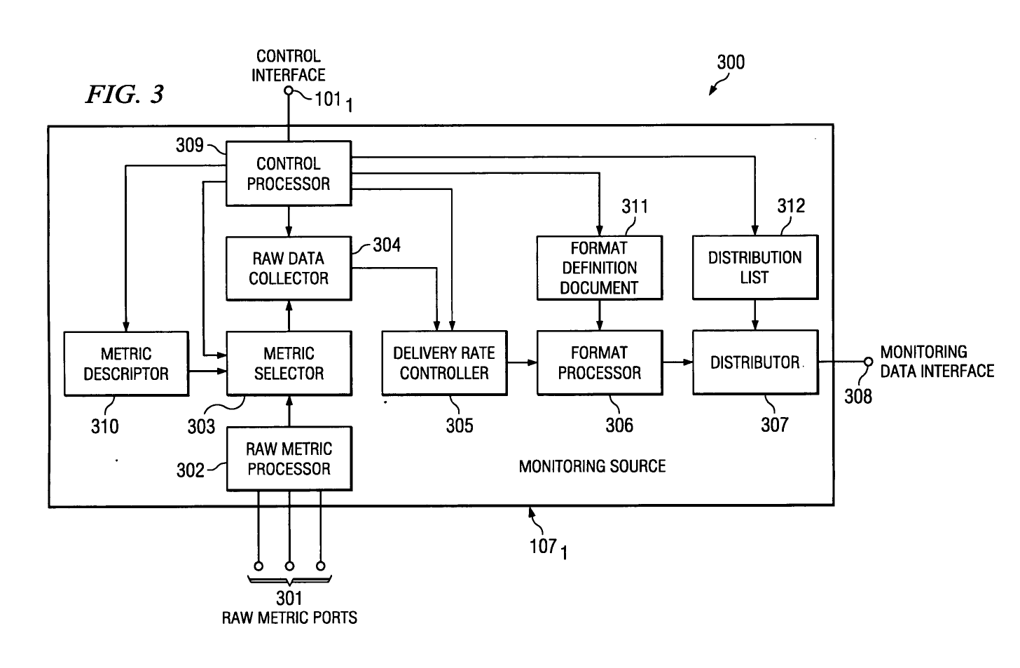

FIG. 3 shows an exemplary system 300 according to one embodiment of the present invention, which shows an exemplary implementation of a monitoring source in more detail. System 300 includes an implementation of a monitoring source, shown as monitoring source 107₁, which has a metric reporting configuration interface or “control interface” 101₁. As described further hereafter, monitoring source 107₁ has raw metric ports 301 for receiving (of pushed or pulled) raw metrics, such as from instrumentation 103 for monitored component 102. Monitoring source 107₁ further includes raw metric processor 302, metric selector 303, raw data collector 304, delivery rate controller 305, format processor 306, distributor 307, and at least one monitoring data interface 308, which are described further below. Additionally, monitoring source 107₁ includes control processor 309, metric descriptor 310, format definition document 311, and distribution 312, which are also described further below.

In general, monitoring source 107₁ is a component that gathers or stores monitoring data about monitored components, such as monitored component 102 (of FIG. 1) in an environment. Monitoring source 107₁ has two main interfaces: 1) the monitoring data interface 308 for distributing the actual monitoring data or event (e.g., to monitoring tools, such as monitoring tool 105 of FIG. 1) and 2) control interface 101₁ (or “metric reporting configuration interface”) for receiving control instructions.

Raw monitoring data is received for various metrics at the raw metrics ports 301 from raw metric sources, such as from instrumentation 103 coupled to monitored component 102 in FIG. 1. The raw metric processor 302 stores raw metric data and converts the raw metric data into a digital representation that corresponds to the metric definition provided in the metric descriptor 310. In certain embodiments, there may be multiple metric definitions that use the same raw metric data. The metric descriptor 310 is a formal representation (e.g. in XML format) that defines each raw metric in terms of the
metric name,
metric association (references to component descriptions to which the metric is associated),
data type,
unit, and
definition (as human-readable text defining semantics).

The subsequent metric selector 303 refers to the metric descriptors 310 and selects the metrics that have been enabled. That is, metric selector 303 filters out from the incoming raw metric data those metric descriptors that are enabled. Metrics that are not referenced by any metric descriptors may not be stored by monitoring source 107₁ nor processed further.

In certain embodiments, monitoring source 107₁ provides an inward facing programmable interface (i.e., control interface 101₁). Control interface 101₁ may be use by the monitoring tool or by a monitored component of monitoring source 107. That is, this interface 101₁ is used by the monitored environment to register meta-data, models, and their corresponding meta-models for the monitored environment, such as described in various ones of the related applications incorporated herein by reference above. Furthermore, as the monitored component changes, the interface is used to reflect these changes as registered in the monitoring source. The registered information is used to support the implementation of the metric reporting configuration interface 101.

Metrics that have been enabled are further passed on to the raw data collector 304, an intermediary store that exists for each enabled metric. The purpose of the raw data collector 304 is to adjust the receiving rate for metrics with the desired delivery rate. In one embodiment, when a higher delivery rate is chosen than the actual receiving rate, metric values are repeatedly reported from the intermediate store in the raw data collector 304. When the delivery rate is lower than the receiving rate, metric values may simply be overwritten (and lost) after new raw metric values have arrived before current values could be delivered. The raw data collector 304 may also apply some different policy than overwriting in this manner. It may contain a queue of values and perform some interpolation for delivering a metric value at due time.

The following delivery rate controller 305 determines the delivery rate that has been defined for a metric by accessing metric values from the intermediate store in the raw data collector 304. Various alternatives exist for determining when a monitored metric is to be delivered, including as examples the following:
fixed time intervals (e.g. every 5 minutes),
flexible time intervals within bounds (e.g. minimum interval=1 minute, maximum_interval=60 minutes), and/or
when the raw value has changed (immediate),
based on priority or utility.

After the delivery rate controller 305 has triggered the delivery of a metric value obtained from the intermediate store in the raw data collector 304, the subsequent format processor 306 applies a transformation in the raw metric value(s) in order to generate its final representation, as expected by the destinations of the monitoring data record. The transformation performed by the format processor 306 is described and controlled by the format definition document 311 that defines the final representation of the monitoring data record that will be sent out. This document 311 is machine readable.

The final processing step is performed in the distributor component 307 that disseminates the monitoring data record to all destinations that have subscribed to the corresponding metric. Subscribers, such as various monitoring tools, are described in the automatically maintained distribution list document 312. In certain embodiments, in addition to or instead of distributing the monitoring data to recipients (e.g., monitoring tools), it may be stored to a data store, such as monitoring data store 104 of FIG. 1, which may be accessible by various monitoring tools that desire such information.

The various control functions performed by the exemplary components of monitoring source 107₁ can be controlled through the control interface 101₁ linked to the control processor 309. The task of the control processor 309 is to translate control instructions received in form of invocations of control methods into respective changes in internal control data, such as the metric descriptor 310, the format definition document 311, and the distribution list 312. Changes in such configuration parameters made via control interface 101₁ will thus affect the processing of monitoring data in the monitoring source 107₁.

The following methods are examples of operations that may be supported by control interface 101₁ according to embodiment of monitoring source 107₁:

selectRawMetricByName(metric), which is an instruction for selecting a raw metric for processing;

selectDeliveryRateForMetric(metric, rate), which is an instruction for selecting the delivery rate for a metric;

selectCollectionRateForMetric(metric,rate), which is an instruction for selecting the collection rate for a metric;

selectDeliveryLatencyForMetric(metric, latency), which is an instruction for selecting the latency for metric delivery;

selectCollectionLatencyForMetric(metric,latency), which is an instruction for selecting collection latency for metric collection;

defineMetricFormat(metric, formatDef), which is an instruction for uploading the format definition document (such as an XML XSLT translation document) that is (applied to the specified metric. the document formatDef described a transformation which is applied to the metric data that are obtained from the monitoring source specified by metric. This allows control of the output format of monitoring date;

subscribe(metric, destDesc), which is an instruction for subscribing the destination defined by the destination descriptor to receive the specified metrics;

unsubscribe(metric, destDesc), which is an instruction for unsubscribing the destination defined by the destination descriptor to receive the specified metrics.

Thus, the above instructions and/or others that may be supported by a given implementation of control interface 101₁ may be used for programmatically defining (e.g., changing) the metric reporting configuration parameters of monitoring source 107₁. For instance, a process (e.g., as on monitoring controller 106 and/or monitoring tool 105 of FIG. 1) may utilize such instructions to control the metric reporting configuration parameters.

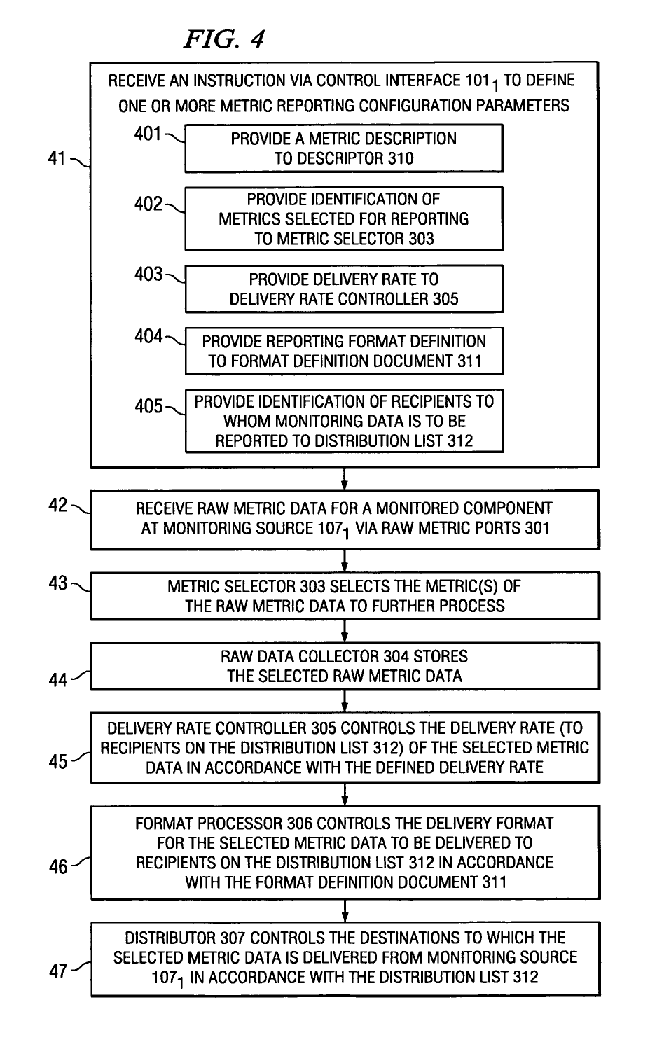

Operation of exemplary monitoring store 107₁ is described further with the operational flow of FIG. 4. In operational block 41, instructions are received via control interface 101₁ to define one or more metric reporting configuration parameters. As shown in sub-operational blocks 401-405, this may comprise receiving instructions for defining one or more reporting configuration parameters. That is, one or more of sub-operational block 401-405 may be performed for defining the corresponding desired configuration parameters described hereafter with those sub-operational blocks. In sub-operational block 401, an instruction is received that provides a metric description to descriptor 310. In sub-operational block 402, an instruction is received that provides an identification of metrics selected for reporting to metric selector 303, such as the above-mentioned selectRawMetricByName(metric) instruction. In sub-operational block 403, an instruction is received that provides delivery rate to delivery rate controller 305, such as the above-mentioned selectDeliveryRateForMetric(metric, Rate) instruction. In sub-operational block 404, an instruction is received that provides reporting format definition to format definition document 311, such as the above-mentioned defineMetricFormat(metric, formatDef) instruction. In sub-operational block 405, an instruction is received that provides, to distribution list 312, identification of recipients to whom monitoring data is to be reported, such as the above-mentioned subscribe(metric, destDesc) instruction.

In operational block 42, raw metric data is received for a monitored component (such as monitoring component 102 of FIG. 1) at monitoring source 107₁ via raw metric ports 301. In operational block 43, metric selector 303 selects the metric(s) of the raw metric data to further process. Such selection is made in accordance with the metrics specified in sub-operational block 402. In operational block 44, raw data collector 304 stores the selected raw metric data. In operational block 45, delivery rate controller 305 controls the delivery rate (to recipients on the distribution list 312) of the selected metric data in accordance with the delivery rate specified in sub-operational block 403.

In operational block 46, format processor 306 controls the delivery format for the selected metric data to be delivered to recipients on the distribution list 312 in accordance with the format definition document 311. In operational block 47, distributor 307 controls the destinations to which the selected metric data is delivered from monitoring source 107₁ (via delivery port 308) in accordance with the distribution list 312.

Certain embodiments of the present invention enable decoupling of raw metric data delivery and the delivery of processed data. In order to allow adjustment of the reporting rate for monitoring data, the processes of receiving raw metric data and processing and delivering of requested monitoring data is decoupled in certain embodiments of the present invention. Decoupling, in this regard, means that they may be split into separate processing threads that may be initiated independently and that may operate concurrently.

In the exemplary embodiment of FIG. 3, raw metric data delivery is either triggered by the raw metric processor 302 reading a metric value from a raw data source (called “polling”), or the raw data source itself may initiate delivery of metric values by invoking a deliver(value) method on one of the raw metric ports 301 (called “event-based delivery,” or referred to by SNMP as “traps”). In both cases, received monitoring data are delivered to the raw data collector component 304 and stored there. Subsequent arrival of raw data will either overwrite the prior value or add the value to a queue of values. The queue will be bound to some upper limit of elements it can store. In one embodiment, when the queue has been filled, the value that has been stored in the queue for the longest time will be removed, while in another, the value with the smallest value is removed.

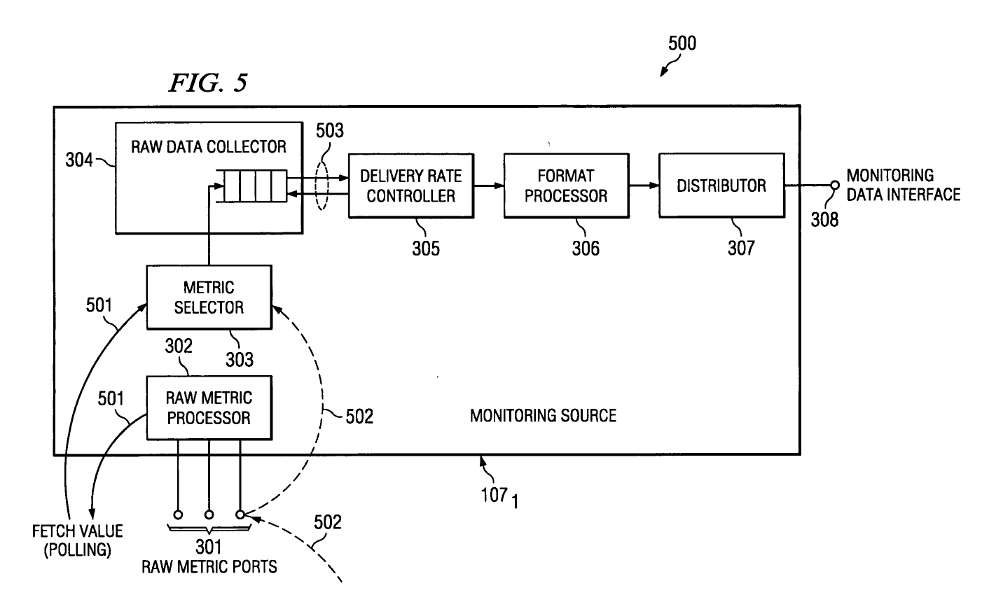

FIG. 5 shows an exemplary system 500 in which the two processing threads for obtaining raw metric data either through polling (thread 501) or trap (502) with both delivering raw data into the queue in the raw data collector 304.

Thread 503 is initiated and controlled by the delivery rate controller 305 obtaining raw data from queue in the raw data collector 304 and executing the format processor 306 and distributor 307 further down the processing pipeline.

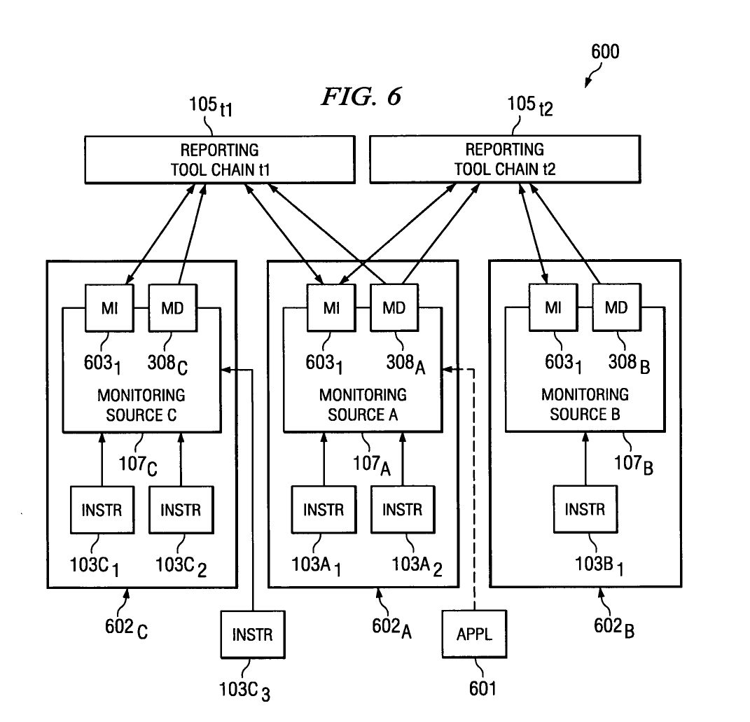

FIG. 6 shows an exemplary system 600 that illustrates a scenario of migrating an application in a monitoring environment. System 600 comprises a number of monitoring sources, shown as monitoring sources 107A-107C, which each include a monitoring data store with corresponding interface (shown as “MD” 308A-308C, respectively) and metric definitions and component descriptions with corresponding interface (each shown as metric introspection interface 603). Metric introspection interface 603 is an exemplary implementation of control interface 101 described above. System 600 further includes instrumentation for collecting monitoring data for monitored components (not shown) for storage to the monitoring data stores 308A-308C of monitoring sources 107A-107C. Instrumentations 103A₁ and 103A₂ collect monitoring data and store such monitoring data to MD 308A of monitoring source 107A; instrumentation 103B₁ collects monitoring data and stores such monitoring data to MD 308B of monitoring source 107B; and instrumentations 103C₁-103C₃ collect monitoring data and store such monitoring data to MD 308C of monitoring source 107C. Reporting tool chains 105t₁ and 105t₂ are included, which are described further below. Reporting tool chain 105t₁ accesses monitoring sources 107A and 107C, and reporting tool chain 105t₂ accesses monitoring sources 107A and 107B in this example. These tool chains may also provide system administrators with information about the utilization of the data centers and the behavior of the applications.

Accordingly, system 600 provides a monitoring environment that has of a number of monitoring sources 107A-107C and a number of tools 105t₁-105t₂ that access, process, store and report monitoring data. The monitoring sources are implemented for different data center locations 602A-602C, respectively, in this example.

Further, in this example, application 601 initially resides in data center 602C and is monitored by instrumentation 103C₃. Monitoring data is delivered from instrumentation 103C₃ to monitoring source 107C. Reporting tool chain 105t₁ receives monitoring data for application 601 through monitoring source 107C.

Assume that application 601 is migrated to the data center 602A, initiated by a system administrator or monitoring tool. In one embodiment, this event causes a notification to be sent to both reporting tool chains alerting them to the fact that application 601 has moved, and hence, that the monitoring data for it is no longer available from monitoring source 107C. Consequently, tool chains 105t₁ and 105t₂ will reconfigure so as to obtain the data about application 601 from monitoring source 107A, which in turn, obtains data about application 601 from its new instrumentation 103A₂. The tool chain uses metric introspection interface 603 to retrieve the new definitions for the metrics of interest, and use this information to subsequently retrieve the monitoring data for application 601 from monitoring data interface 308A. In an alternate embodiment, following the migration of application 601, the monitoring data for application 601 may be migrated to monitoring source A.

Comprehensive control or “programmability” of monitoring sources (instrumentations) in terms of:
selecting which metrics are reported,
at which rate (minimum and maximum numbers of records per metric per time) metrics are collected and/or reported,
with which latency (minimum and maximum delays with which metrics are collected and/or reported),
to which destination monitoring data is distributed, and
in which format monitoring data is reported,
or priority based on which monitoring data is collected and distributed
   is not available in traditional monitoring systems. These parameters are typically subject to manual customization when a monitoring solution is integrated. Changing one of the parameters has traditionally required manual reconfiguration. As described above, embodiments of the present invention enable making the reconfiguration of a set of metric reporting parameters “programmable” without requiring manual intervention.

Thus, embodiments of the invention enable programmatically controlling a collection of monitoring data in monitoring sources (instrumentations) provided in a system. In many instances, monitoring data can be large, and transmitting and storing monitoring data can consume significant resources. This may have an impact on the monitored system since transmission and collection of monitoring data also occurs and consumes resources in the monitored environment. Transmitting monitoring data consumes bandwidth in the shared networking infrastructure.

Providing the capability to control when, where, which and at which rate monitoring data is gathered, processed and stored in a system thus is advantageous. Making this control capability available through programmable interfaces (APIs) allows further automated adjustment of where and when and at which rate monitoring data is collected in the system.

Embodiments of the invention provide a mechanism to control the resources used to transmit and store monitoring data. Embodiments of the invention allow monitoring services to programmatically actuate the collection, transmission and storage of monitoring data according to a purpose. Embodiments of the invention enable flow control of monitoring data flows. This is desired, for instance, when transmission resources are needed for other purposes in a system or when destinations of monitoring data cannot process data at arrival rate.

Thus, in view of the above, exemplary embodiments of the present invention provide one or more monitoring sources that provide a control interface (a set of methods) that allows defining metric reporting configuration parameters, such as selecting which metrics are reported by the source, at which rate (minimum and maximum numbers of records or data points per metric per time), to which destination, and in which format. All these parameters can be changed and redefined during run-time by invoking methods at the control interface. In certain embodiments, the monitoring source also provides a distribution capability in which clients to monitoring data can subscribe for receiving monitoring data from the monitoring source.

In certain embodiments, per-subscriber customization of metric reporting configuration parameters may be supported. For instance, per-subscriber customization of metric reporting formats and/or delivery rates may be supported. Such an implementation may be supported by using per-subscriber instances of metric selector 303, raw data collectors 304, delivery rate controllers 305, format processors 306, and/or distributors 307.

What is claimed is:

1. A method comprising:
providing a metric reporting configuration interface for enabling configuration of metrics included in monitoring data collected for at least one monitored component;
supporting, by said metric reporting configuration interface, defining of configuration parameters of at least one metric to be reported in monitoring data collected for the at least one monitored component;
collecting monitoring data for the at least one monitored component; and
reporting the monitoring data in accordance with the defined configuration parameters.

2. The method of claim 1 wherein said providing comprises:
providing said metric reporting configuration interface for a monitoring source.

3. The method of claim 2 wherein said collecting comprises:
collecting said monitoring data at said monitoring source.

4. The method of claim 3 wherein said reporting comprises:
reporting said monitoring data by said monitoring source to a monitoring tool.

5. The method of claim 1 wherein said providing comprises:
providing said metric reporting configuration interface for enabling programmatic configuration of said metrics included in said monitoring data collected for said at least one monitored component.

6. The method of claim 1 wherein said supporting defining of configuration parameters comprises supporting defining at least one of the following configuration parameters:
metric selection, metric delivery rate, reporting format definition, reporting distribution list, metric collection rate, delivery latency, metric availability events, and collection latency.

7. The method of claim 1 further comprising:
changing the defined configuration parameters via the metric reporting configuration interface in response to a value detected in the collected monitoring data.

8. The method of claim 7 wherein said changing is performed autonomously.

9. The method of claim 1 further comprising:
changing the defined configuration parameters via the metric reporting configuration interface in response to a change detected in a monitored environment that comprises the at least one monitored component.

10. The method of claim 9 wherein the change comprises the at least one monitored component migrating within the monitored environment.

11. The method of claim 9 wherein said changing is performed autonomously.

12. A monitoring source comprising:
a raw metric interface for receiving monitoring data for at least one monitored component; and
a reporting configuration interface for receiving control data for controlling configuration parameters of at least one metric of said monitoring data.

13. The monitoring source of claim 12 wherein said raw metric interface for receiving said monitoring data is operable to receive said monitoring data that is pushed to said raw metric interface.

14. The monitoring source of claim 12 wherein said raw metric interface for receiving said monitoring data is operable to acquire said monitoring data.

15. The monitoring source of claim 12 further comprising:
control processor for translating control instructions received via said reporting configuration interface into control data for controlling one or more internal reporting configuration elements of said monitoring source.

16. The monitoring source of claim 15 wherein said one or more internal reporting configuration elements comprise at least one of the following:
metric descriptor, metric selector, raw data collector, delivery rate controller, format definition document, format processor, and distribution list.

17. The monitoring source of claim 15 wherein said one or more internal reporting configuration elements comprise:
metric descriptor for defining said at least one metric of said monitoring data; and
raw metric processor for converting raw metric data, received via the raw metric interface, into a digital representation that corresponds to the metric definition specified by the metric descriptor.

18. The monitoring source of claim 17 wherein said metric descriptor comprises machine-readable information defining the following for said at least one metric:
metric name, metric association, data type, and unit.

19. The monitoring source of claim 17 wherein said one or more internal reporting configuration elements further comprise:
metric selector for selecting metrics that are specified by the metric descriptor as enabled.

20. The monitoring source of claim 19 wherein said one or more internal reporting configuration elements further comprise:
delivery rate controller for controlling the delivery of said monitoring data to a monitoring tool to comply with a delivery rate defined for said monitoring data.

21. The monitoring source of claim 20 wherein said control processor is operable to receive information specifying said delivery rate and provide said defined delivery rate to be used by said delivery rate controller.

22. The monitoring source of claim 20 wherein said one or more internal reporting configuration elements further comprise:
raw data collector for providing an intermediary data store for storing said monitoring data received via said raw metric interface when a receiving rate for said monitoring data received via said raw metric interface differs from the defined delivery rate used by the delivery rate controller.

23. The monitoring source of claim 20 wherein said one or more internal reporting configuration elements further comprise:
format definition document that defines a desired representation used for delivery of the monitoring data to the monitoring tool; and
format processor for transforming raw metric values of the monitoring data received via the raw metric interface to generate the desired representation of the monitoring data as defined by said format definition document.

24. The monitoring source of claim 23 wherein said one or more internal reporting configuration elements further comprise:
distribution list for listing subscribers to whom the monitoring data is to be distributed; and
distributor for distributing the monitoring data in the desired representation to the subscribers listed in the distribution list.

25. The monitoring source of claim 15 wherein said one or more internal reporting configuration elements comprise:
delivery rate controller for controlling the delivery of said monitoring data to a monitoring tool to comply with a delivery rate defined for said monitoring data.

26. The monitoring source of claim 25 wherein said one or more internal reporting configuration elements further comprise:
raw data collector for providing an intermediary data store for storing said monitoring data received via said raw metric interface when a receiving rate for said monitoring data received via said raw metric interface differs from the defined delivery rate used by the delivery rate controller.

27. The monitoring source of claim 15 wherein said one or more internal reporting configuration elements comprise:
format definition document that defines a desired representation used for delivery of the monitoring data to a monitoring tool; and
format processor for transforming raw metric values of the monitoring data received via the raw metric interface to generate the desired representation of the monitoring data as defined by said format definition document.

28. The monitoring source of claim 15 wherein said one or more internal reporting configuration elements comprise:
distribution list for listing subscribers to whom the monitoring data is to be distributed; and
distributor for distributing the monitoring data in the desired representation to the subscribers listed in the distribution list.

29. The monitoring source of claim 12 further comprising:
a communication port for communicating said monitoring data to a monitoring tool.

30. The monitoring source of claim 29 wherein communicating said monitoring data to said monitoring tool comprises:
notifying said monitoring tool that monitoring data is available on said monitoring source, and said monitoring tool pulling said monitoring data from said monitoring tool.

31. The monitoring source of claim 29 wherein communicating said monitoring data to said monitoring tool comprises:
pushing said monitoring data to said monitoring tool.

32. The monitoring source of claim 19 wherein communicating said monitoring data to said monitoring tool comprises:
communicating said monitoring data to one or more monitoring tools identified on a distribution list, wherein said distribution list is configurable via said reporting configuration interface.

33. A system comprising:
monitored component;
instrumentation for collecting monitoring data about said monitored component;
a reporting configuration interface enabling defining of configuration parameters of at least one metric in said monitoring data; and
an interface enabling a monitoring tool to receive reporting of said monitoring data in accordance with the defined configuration parameters.

34. The system of claim 33 wherein said reporting configuration interface supports defining of at least one of the following configuration parameters:
metric selection, metric delivery rate, reporting format definition, reporting distribution list, metric collection rate, delivery latency, metric availability events, and collection latency.

35. The system of claim 33 further comprising:
monitoring data store for storing the collected monitoring data.

36. The system of claim 35 wherein said monitoring data store and said reporting configuration interface are included in a monitoring source.
